(19) United States
(12) Patent Application Publication
(10) Pub. No.: US 2013/0093775 A1
(43) Pub. Date: Apr. 18, 2013

(54) System For Creating A Visual Animation Of Objects

(71) Applicant: Rakan Khaled Y Alkhalaf, Riyadh (SA)

(72) Inventor: Rakan Khaled Y Alkhalaf, Riyadh (SA)

(21) Appl. No.: 13/582,692

(22) PCT Filed: Nov. 30, 2010
(86) PCT No.: PCT/EP2010/068571

§ 371 Date: Sep. 4, 2012

(30) Foreign Application Priority Data
Jul. 6, 2010 (SA) 110310578

(51) Int. Cl. G06T 13/00

(52) U.S. Cl. CPC G06T 13/00
USPC 345/474

(57) ABSTRACT

A system for creating visual animation of objects which can be experienced by a passenger located within a moving vehicle is provided. The system includes: a plurality of objects being placed along a movement path of the vehicle; a plurality of sensors being assigned to the plurality of objects and being arranged such along the movement path that the vehicle actuates the sensors when moving along the movement path; and a plurality of highlighting devices being coupled to the plurality of sensors and being controlled by the sensors such that, in accordance with sensor actuations triggered by the movement of the vehicle, a) only one of the plurality of objects is highlighted by the highlighting devices to the passenger at one time, and b) the objects are highlighted to the passenger in such a sequence that the passenger visually experiences an animation of the objects.

### BACKGROUND

The present invention relates to a system for creating a visual animation of objects which can be experienced by a passenger located within a moving vehicle.

In the last decades, passenger traffic like car traffic has been steadily increased. Due to this increase, a lot of advertising is done on huge signs which are e.g. placed along the roads in order to present advertising information to the passengers while they are travelling. Normally, companies rent a flat two-dimensional space on an advertising sign filled with advertising information like product information.

However, since the travel speed of vehicles carrying the passengers is usually high, passengers only have a limited time slot in order to capture the advertising information presented on the advertising sign. This in return means that the amount of advertising information which can be presented by a company is also limited.

In view of the above, it is an object of the present invention to enable a company to present more advertising information to a passenger even if the passenger moves within the vehicle at high speed.

### SUMMARY OF THE INVENTION

According to an embodiment of the present invention, a system for creating visual animation of objects which can be experienced by a passenger located within a moving vehicle is provided. The system includes: a plurality of objects being placed along a movement path of the vehicle; a plurality of sensors being assigned to the plurality of objects and being arranged such along the movement path that the vehicle actuates the sensors when moving along the movement path; and a plurality of highlighting devices being coupled to the plurality of sensors and being controlled by the sensors such that, in accordance with sensor actuations triggered by the movement of the vehicle, a) only one of the plurality of objects is highlighted by the highlighting devices to the passenger at one time, and b) the objects are highlighted to the passenger in such a sequence that the passenger visually experiences an animation of the objects.

One effect of this embodiment is that, due to the fact that a plurality of objects are successively presented to the passenger, the passengers attention can be attracted for a longer period of time, compared to the case were only one object (like an advertisement sign) is used. In the context of the present invention, the term “object” may mean any type of physical structure being suitable to present visual information like advertising information (e.g. product information) to a passenger. Alternatively, the term “object” may mean any physical structure being suitable to generate, in combination with other objects, artistic effects like an animation of an animal (like an animation of Superman). Due to the usage of sensors, it is possible to highlight only one of the objects at one time which means that the attention of a passenger moving together with the vehicle is only drawn to one object at one time. In this way, it can be ensured that the right visual information is presented to the user at the right time in order to avoid confusion. In other words: Due to the object highlighting, it is possible to precisely control a “stream” of visual information units to be presented to the passenger.

According to one embodiment of the present invention, “highlighting” of an object may mean to make an invisible object visible or to emphasize an already visible object even more, compared to other visible objects.

According to one embodiment of the present invention, the sensors may be light sensors, infrared sensors, pressure sensors or acoustic sensors and the like. For example, light sensors may actuate the highlighting devices if the vehicle crosses a particular borderline (light barrier) monitored by the light sensors. Alternatively, sensors may be used which detect any kind of movement within a particular distance range from the sensor (movement detectors). Pressure sensors may be placed along the movement path of the vehicle such that the vehicle actuates the pressure sensors (by causing a pressure force on the pressure sensors) as soon as the vehicle moves over these sensors. Acoustic sensors may be used adapted to generate a highlighting device trigger signal as soon as the noise of the moving vehicle exceeds a predetermined threshold value, meaning that the distance between the acoustic sensors in the vehicle has fallen under a predetermined threshold value.

According to one embodiment of the present invention, to each of the objects, two sensors are respectively assigned. A first one of the two sensors triggers a start of the highlighting of the corresponding object, and a second one of the two sensors triggers an end of highlighting of the corresponding object. One effect of this embodiment is that the start and the end of the highlighting of one object are precisely aligned to the movement of the vehicle. For example, if the vehicle increases its speed, meaning that the passenger within the vehicle has less time to view an object, the end of highlighting is triggered earlier. In this way, the sensor arrangement adapts its triggering behaviour exactly to a varying speed of the vehicle. There may be situations in which this embodiment does not yield acceptable results. For example, if the speed of the vehicle is too fast or too slow, there may be the situation that the animation would be too fast or too slow (too many or not enough objects per second will be viewed by the passenger). In order to avoid this, according to one embodiment of the present invention, a speed sensor is installed (preferably before the series of objects) which detects the speed of the vehicle and decides, based on the detected speed of the vehicle, whether the speed of the vehicle is suitable to view the animation or not (e.g. a speed of 30 km/h-70 km/h may be a suitable speed range). If the speed of the vehicle is too fast or too slow, the animation can be blocked. The suitable speed range also depends on the distance between the passenger and the objects viewed as well as the size of the objects. All these factors can be taken into account when determining whether an animation should be blocked or not.

According to one embodiment of the present invention, to each of the objects, only one sensor is respectively assigned which triggers a start of the highlighting of the object. This means that only the start of the highlighting, however not the end of the highlighting of the object is triggered by a sensor. However, in order to make sure that the highlighting of an object is terminated in time, according to one embodiment, a first timer device may be respectively connected to each highlighting device, wherein each first timer device is adapted to automatically trigger an end of the highlighting of the corresponding object as soon as a particular period of time after the start of the highlighting has been passed. In this way, the first timer device replaces a second sensor responsible for triggering an end of the highlighting of the object. One effect of this embodiment is that one sensor per object can be saved, thereby saving costs. However, this embodiment is not capable of precisely adapting its triggering behaviour to varying speeds of the vehicle. That is, if the period of time after which the end of highlighting of the object is triggered is not calculated correctly, the end of the highlighting may be triggered too soon or too late. Consequently, this embodiment may be suitable for vehicles like trains or subways where the speed is constant or at least predictable.

In order to calculate the period of time, according to one embodiment, a speed measurement device may be respectively coupled to each first timer device, wherein each speed measurement device may be adapted to measure the speed of the moving vehicle at the time where the start of the highlighting is triggered. Alternatively, a single speed sensor may be fixed before the series of objects in order to detect the speed of the vehicle. The period of time after which a first timer device triggers the end of the highlighting may then be determined based on the speed measurement. In this context, it may be assumed that the speed of the vehicle measured remains constant for the whole period of time needed by the vehicle to pass the object. However, if the speed increases or decreases, the first timer device will trigger the end of highlighting too soon or too late.

According to one embodiment of the present invention, a second timer device may respectively be connected to each highlighting device, wherein each second timer device may be adapted to block highlighting of a corresponding object if the object has already been highlighted within a particular period of time immediately before. One effect of this embodiment is that it is not possible to highlight a particular object twice within a predetermined period of time. Due to this, it is guaranteed that a passenger of a first vehicle can experience an animation of a series of objects without disturbance caused by a second vehicle moving close behind the first vehicle. That is, it is only possible for the passenger located within the first vehicle to experience the animation of objects. The passenger located in the second vehicle will not be able to experience an animation of objects or an undisturbed animation of objects. Only if the distance between the first vehicle and the second vehicle is large enough, and therefore a predetermined time has been passed, a further animation of objects may be allowed by the second timer. In this case, the further animation of objects has no disturbing effects on the preceding animation of objects.

According to one embodiment of the present invention, the triggering of the start of the highlighting and the triggering of the end of the highlighting is carried out such that the viewing angle range experienced by the passenger is the same for each of the successive objects viewed, i.e. for each of the series of objects of the object animation. According to this embodiment, it is possible for the passenger experiencing animation of objects to always look into the same direction, meaning that the passenger does not have to move his head in order to experience the animation of objects. In this way, a convenient way of experiencing the animation of objects is guaranteed.

According to one embodiment of the present invention, the viewing angle range extends between five degrees and ten degrees, meaning that only a very slight movement of the head may be necessary is at all (this viewing angle variation may also be covered by the movement of the eyes).

According to one embodiment of the present invention, the vehicle may be a car, a train, a bus, a subway, an elevator, a motor bike, a bike, and the like. Correspondingly, the movement path of the vehicle may be a road (e.g. high-way), a railway of a train, a railway of a subway, a shaft of an elevator, or the like.

In order to highlight the objects, several possibilities exist. For example, each highlighting device may comprise an illumination device capable of illuminating the corresponding objects (using light). For example, illumination devices may be positioned within an object and/or in front of an object and/or behind an object and/or above an object. Each illumination devices may be adapted to illuminate the corresponding object as soon as the start of the highlighting of the object has been triggered, and to end illumination of the object as soon as the end of the highlighting of the object has been triggered. The illumination device may for example be a lamp comprising a plurality of LEDs and a mirror focusing device in order to direct the light generated by the LEDs onto the corresponding object. The illumination of the devices has the advantage that the animation of objects can also be experienced at night time where it may not be possible for a passenger to see an object without illumination. In this way, it can be ensured at night time that only one object is visible one time. However, a similar highlighting effect may also be achieved during day time assuming that the illumination power of the illumination devices is strong enough or that the objects to be illuminated are located in a shadowed area, so that the illumination effect is large enough.

According to an embodiment of the present invention, each highlighting device comprises a shielding device including a shielding element being positioned in front of the object, wherein the shielding device is adapted to remove the shielding element to enable visibility of the object as soon as the start of the highlighting of the corresponding object has been triggered, and to place the shielding element in front of the object as soon as the end of the highlighting of the corresponding object has been triggered. This kind of highlighting can for example be used during daytime if an illumination would not produce a significant highlighting effect. Both types of highlighting (highlighting by illumination or highlighting by using mechanical means) may be combined with each other, i.e. some of the objects may be mechanically highlighted, and some of the objects may be highlighted using light and some of the objects may be highlighted using both types.

According to one embodiment of the present invention, the objects are placed substantially along a line which runs in parallel to the movement path of the vehicle. For example, the line of objects may run beside the movement path, e.g. besides a road, or may run above the movement path, e.g. above a road. It may also be possible to combine both alternatives within one animation sequence, i.e. a part of the objects may be placed beside the movement path, and a path of the objects may be placed above the movement path.

According to one embodiment of the present invention, the objects are three-dimensional objects. However, it is to be understood that the objects may also be two-dimensional objects. The objects may also be screens onto which an image is shown (either in printed form or electronically on a monitor being part of the object). Using a monitor as at least part of the object, it is possible to change the picture displayed on demand, i.e. change at least a part of the sequence on demand).

According to one embodiment of the present invention, the objects are movable as a whole in parallel or perpendicular to the movement path of the vehicle. For example, an object may be mounted on a sliding means, the sliding means being adapted to slide the object parallel to the movement path or perpendicular to the movement path. In this way, a part of the animation may be achieved by the movement of one object instead of a series of several objects.

According to one embodiment of the present invention, the objects are stationary as a whole, however parts of the objects are movable in correspondence with the highlighting of the objects such that the movement of the parts of the objects form a part of the animation of the objects. For example, assume that each of the objects has the shape of a human. In this case, an arm of each of the objects may be respectively movable relative to a body of the object in order to create a corresponding animation effect (arm movement).

The objects may be enlargeable. Due to this enlarging, an impression may be generated simulating a movement of the object towards the passenger viewing the object. For example, the object may have the shape of a human having a flexible outer surface which may be enlarged by pumping gas into the object, thereby enlarging its flexible outer surface (like pumping up a balloon).

According to an embodiment of the present invention, the plurality of objects is split up into at least two series of objects, the objects of each series of objects being respectively aligned along the movement path such that the passenger experiences one animation or simultaneously at least two different animations when moving along the movement path.

According to an embodiment of the present invention, an animation is displayed by highlighting objects of a first series of objects and is then displayed by highlighting objects of a second series of objects, wherein the switching between the first series and the second series is triggered by a further vehicle moving besides the vehicle of the passenger.

According to an embodiment of the present invention, the system may further include a plurality of sound devices assigned to the plurality of objects, wherein each sound device creates a part of a sound pattern in a way that the passenger located within the vehicle experiences a continuous sound pattern corresponding to the animation of objects. The plurality of sound devices coupled to the plurality of sensors may be adapted such that the generation of sound by a sound device is started as soon as the start of the highlighting of the corresponding object is triggered by the sensors, and is terminated as soon as the end of the highlighting of the corresponding object is triggered. In this way, each of the plurality of sound devices creates a part of a continuous sound pattern like a melody, which means that not all of the sound devices do have to generate sound at all times. However, it may also be possible to synchronize the sound devices and to let them generate the same sound pattern all the time.

According to one embodiment of the present invention, the system further includes a wireless sound transmitting device being adapted to transmit sound information to a wireless sound receiving device located within the vehicle. For example, the passenger of the vehicle may tune the receiving device (for example a radio receiver) to a particular receiving frequency, thereby ensuring that sound information is played within the vehicle using corresponding loudspeakers as soon as the vehicle passes the plurality of objects. Alternatively, sound information may be broadcasted to all fm and am frequencies at the same time (e.g. as side information in order to not disturb the listener listening to a fm or am frequency program). The thus received sound information could be stored within the wireless sound receiving device and activated when reaching the series of objects. In this way, the listener would not have to adjust his frequency or change it. Timing information may also be included within the sound information in order to ensure that the sound is played within the vehicle at the right time (i.e. not before or after having passed the objects). The sound played may be mixed with other sound currently played. For example, the sound associated with the animation may be mixed with a traffic announcement currently received. In this way, the reception of a radio program does not have to be interrupted. In the following, further embodiments of the invention will be disclosed.

According to one embodiment of the present invention, you can see an animation (short film) while you are driving on the highway.

According to one embodiment of the present invention, several boards high enough to stand and to be viewed from a far away distance are used as objects. It has to be arranged next to each other, and each one of these boards has a picture of a movement of the animation (as known the animation pictures contain multiple frames being viewed one after another). The frames should be tented and contain lamps at the back of it. Moreover, each one of the boards should have the lamps attached with an electrical circuit, e.g. the electrical circuit being shown in FIG. 15.

According to one embodiment of the present invention, people ride a car in the middle of the road on a highway. Then the car passes by the sensor [2] (see FIG. 15) where the lights will be switched on for the first frame where the driver or the people inside the car will see and recognize the first frame, then will pass through the second sensor [6] and the lights of the first frame will be closed and of course because it is tented they wont be able to see the first frame. Each next board or frame should begin from the view that the previous board ended with (Viewer Wise). As a consequence, the person can see and view the boards as a film while he is driving on the highway road. It is the same concept of cartoons but being developed.

According to one embodiment of the present invention, music may be played that can be heard from the people who are in the car, so instead of the lamps in the circuits being drawn in FIG. 15 we can use sounds. These sounds can be cut when we want and switched on when we want depending on the vehicle's movement.

According to one embodiment of the present invention, 3-Dimensional Objects or 2-Dimensional frames maybe used to be seen as if they are real objects moving beside the road. So for instance, we can see Superman running beside us while the passenger is moving with a car.

According to one embodiment of the present invention, in each frame in order gain an animation effect while going in a high speed you need either to stop the vehicle before you switch to the next frame or move the frame its self before switching to the next frame. When the passenger within the vehicle see that image after image gets illuminated the vehicle will cut some distance before the image goes to the off mode and of course that should be took in consideration when the viewers sees the next frame where the next frame should start the view (Switch on) on the angle that the previous frame ended up with, in order to give the viewer a stable view. So a principle is “The next frame angle view will start from where the previous frame ended”.

According to one embodiment of the present invention, the 3-Dimensional animation objects are being viewed as real objects from the boards or screens. That means as an example the first screen will contain a face view of a person, and of course a face contains a nose, eyes mouth . . . etc. So if the nose is desired to appear as if it is getting out of this image we can put a suitable size pyramid on the same spot of the nose and of course on the same copy of the image and then a bigger and taller image of the nose will be stuck on the third image and so on and so forth. At the end and when we take a ride on the car and the screens begin to flash, we will see the animation as if it is going out of the image screen. Moreover, this can be done without using a board. In other words, only objects may be used in a way that they are arranged to show an animation.

According to one embodiment of the present invention, the objects are fixed in way that they need to be visioned as a real animated objects. Accordingly, they need to be sequenced in way to guarantee not to demolish the animation series of objects. For that a concept of “The angle of vision of the second flashing object should be switched on from where the angle of the first object has been switched off” may be implemented meaning that the viewer will be able to see the abject as if it is standing still and without miss or vision uncertainty. Let's assume that there will be no angle consideration in the road animated objects. What may happen is that the viewer will view the first object from an angle being different than the angle from which he will view the second object. This would of course demolish the harmony of the animation. Thus, the sequence of these objects and boards should be always arranged or highlighted such that the viewer recognizes the object as if it is one object in order to reach the optimum level to view such animation. The viewer is seeing all objects as one object and he is not concerned on anything but to recognize the object and to recognize the illumination and animation. So for that if he saws the first object in an angle and then he saws the second one in another angle this will demolish the harmony.

According to one embodiment of the present invention, the animation may move towards the viewer and outward the viewer in as if the object character is heading towards the viewer or away from the viewer. In order to realize this, the objects may be fixed along a road in a way that the each next object will be closer in distance to the viewer than the previous one in a way that an animation is created that seems to be going nearer and towards the viewer.

According to one embodiment of the present invention, a timer is provided which is responsible to give the animation producer the ability to adjust the animation depending on the animation itself. The purpose of this timer is to lock switching on the sensor of the flash lights in order not to let two cars behind each other have flash lights switching on and off at the same time. Only the first car will only enjoy the view while the next car behind wont be able to do so. This is to guarantee not to demolish the illumination of the sequence of the objects. For instance, the producer can adjust the timer to stop for three seconds on all object circuits. What will happen here is that the first car is going to pass by the sensor then the circuit will lock immediately so no car behind this specific car is going to view the animation until e.g. three seconds pass by.

The objects can even be placed along movement paths with sharp turns and slopes.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic drawing of a system for creating visual animation of objects according to one embodiment of the present invention.

FIG. 2 shows a schematic drawing of a system for creating visual animation of objects according to one embodiment of the present invention.

FIG. 3 shows a schematic drawing of a system for creating visual animation of objects according to one embodiment of the present invention.

FIG. 4 shows a schematic drawing of a system for creating visual animation of objects according to one embodiment of the present invention.

FIG. 5 shows a schematic drawing of a system for creating visual animation of objects according to one embodiment of the present invention.

FIG. 6 shows a schematic drawing of a system for creating visual animation of objects according to one embodiment of the present invention.

FIG. 7 shows a schematic drawing of a system for creating visual animation of objects according to one embodiment of the present invention.

FIG. 8 shows a schematic drawing of a system for creating visual animation of objects according to one embodiment of the present invention.

FIG. 9 shows a schematic drawing of a system for creating visual animation of objects according to one embodiment of the present invention.

FIG. 10 shows a schematic drawing of a system for creating visual animation of objects according to one embodiment of the present invention.

FIG. 11 shows a schematic drawing of a system for creating visual animation of objects according to one embodiment of the present invention.

FIG. 12 shows a schematic drawing of a system for creating visual animation of objects according to one embodiment of the present invention.

FIG. 13 shows a schematic drawing of a system for creating visual animation of objects according to one embodiment of the present invention.

FIG. 14 shows a schematic drawing of a system for creating visual animation of objects according to one embodiment of the present invention.

FIG. 15 shows a schematic drawing of a system for creating visual animation of objects according to one embodiment of the present invention.

FIG. 16 shows a schematic drawing of a system for creating visual animation of objects according to one embodiment of the present invention.

FIG. 17 shows a schematic drawing of a system for creating visual animation of objects according to one embodiment of the present invention.

FIG. 18 shows a schematic drawing of a system for creating visual animation of objects according to one embodiment of the present invention.

FIG. 19 shows a schematic drawing of a system for creating visual animation of objects according to one embodiment of the present invention.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

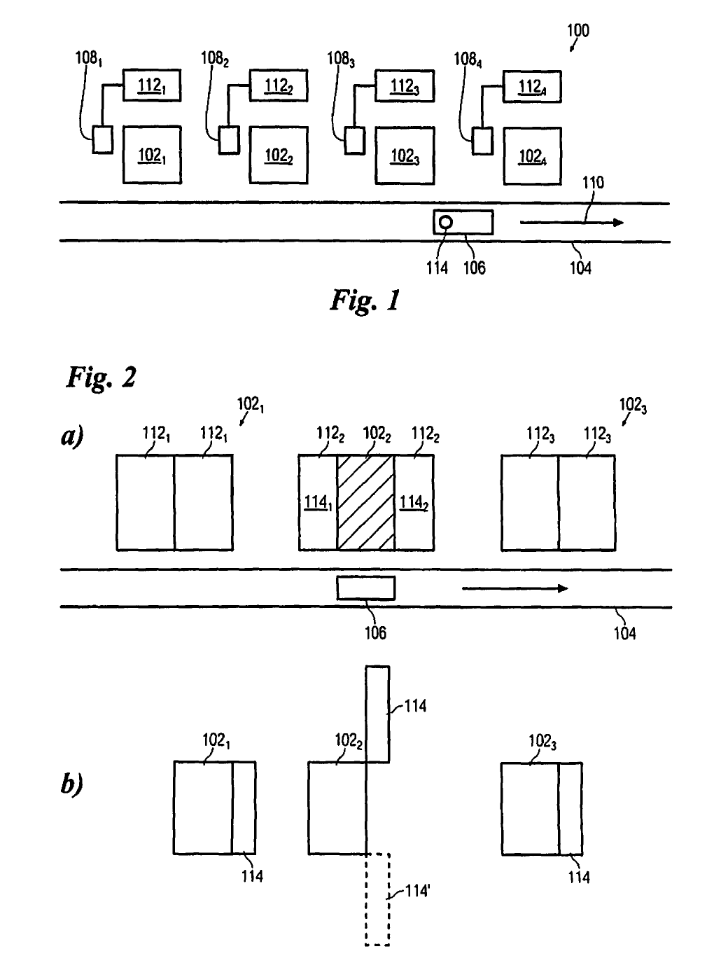

FIG. 1 shows a system 100 for creating a visual animation of objects, comprising: a plurality of objects 102 being placed along a movement path 104 of a vehicle 106; a plurality of sensors 108 being assigned to the plurality of objects 102 and being arranged such along the movement path 104 that the vehicle 106 actuates the sensors 108 when moving along the movement path 104 in a direction indicated by arrow 110; and a plurality of highlighting devices 112 being coupled to the plurality of sensors 108 and being adapted such that, in accordance with the sensor actuations triggered by the movement of the vehicle 106, a) only one of the plurality of objects 102 is highlighted by the highlighting devices 112 to a passenger 114 within the vehicle 106 at one time, b) the objects 102 are highlighted to the passenger 114 in such an order that the passenger 114 visually experiences an animation of the objects 102.

In FIG. 1, a situation is shown where the vehicle 106 has already passed object 102₃ and now passes object 102₄. Sensor 108₃ detects that vehicle 106 has passed object 102₃ and has therefore caused highlighting device 112₃ to finish highlighting of object 102₃. On the contrary, sensor 108₄ has already detected that vehicle 106 is currently passing object 102₄ and therefore has caused highlighting device 112₄ to highlight object 102₄ as long as vehicle 106 is passing object 102₄. As soon as vehicle 106 has passed object 102₄, sensor 108₄ will detect this and cause highlighting device 112₄ to end the highlighting of the object 102₄.

FIG. 2a shows a front view of a first example of a possible realization of the highlighting devices 112. FIG. 2a shows a situation where the vehicle 106 is currently passing the second one (object 102₂) of three objects 102. The sensors 108 (not shown in FIG. 2) detect this and cause the highlighting device 112₂ to reveal the object 102₂ which normally (i.e. when no vehicle 106 is passing) is hidden by the highlighting device 112₂. That is, the highlighting devices 112 each comprise a first shielding element 114₁ and a second shielding element 114₂ which respectively are in a closing position when no object 102 is passing (like objects 102₁ and 102₃). As soon as an object is passing, the first shielding element 114₁ and a second shielding element 114₂ are mechanically pulled to the left and to the right (i.e. they move into an opening position), respectively, thereby enabling the passenger 114 to look at the object 102₂. As soon as the vehicle 106 has passed object 102₂, the first and the second shielding elements 114₁, 114₂ will laterally move to the closing position again in which the object 102₂ cannot be viewed anymore. As soon as vehicle 106 passes object 102₃, the shielding elements 114₁/114₂ covering object 102₃ will move from their closing position to an opening position as described before in conjunction with object 102₂, and so on.

One effect of this embodiment is that it is possible to provide an animation effect even at daytime, i.e. at a time at which highlighting an object by illuminating with light may not produce a sufficient highlighting effect.

According to one embodiment of the present invention, the objects 102 may be realized as E-ink boards, i.e. boards on which pictures may be displayed using “electronic ink” in display quality (visibility) comparable to paper, even when displaying colored pictures. In this way, such E-ink boards may be in particular usable during daytime when conventional electronic displays like monitors would have problems to ensure sufficient display quality due to sunlight reflection on the monitor screen.

FIG. 2b shows a side view of an alternative solution of a highlighting device. Here, the shielding elements 114 covering objects 102₁ and 102₃ are respectively in their closing position, wherein shielding element 114 covering object 102₂ is in its opening position. Contrary to FIG. 2a where the shielding elements 114 are pulled along a lateral direction aligned parallel to the moving direction 110 of the vehicle 106, the shielding element 114 in FIG. 2b is moved in a vertical direction being aligned perpendicular to the movement direction 110 of the vehicle 106. As indicated by the dotted lines 114′, the shielding element 114 may also be split up into two parts 114, 114′ which move along directions opposite to each other, respectively.

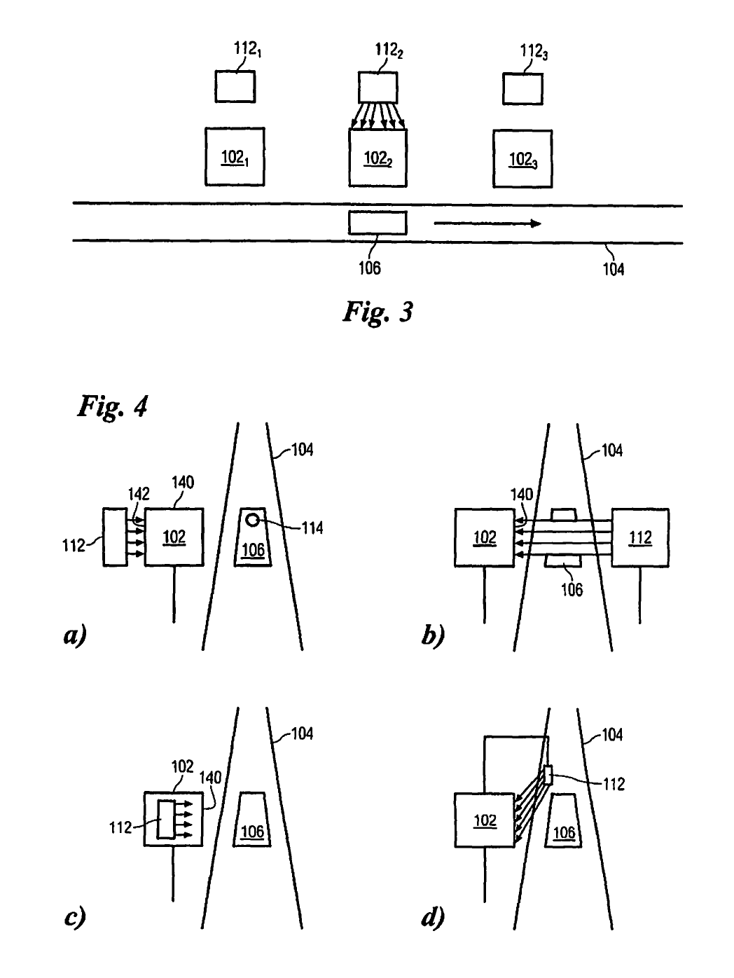

FIG. 3 shows a further possible realization of the highlighting devices as shown in FIG. 1. In contrast to the mechanical realization in FIG. 2, FIG. 3 shows to realize the highlighting devices as illumination devices. In FIG. 3, the vehicle 106 is currently passing the second one (object 112₂) of three objects 102. The sensors 108 detect that vehicle 106 is currently passing object 102₂ and therefore cause illumination device 112₂ to illuminate object 102₂. After vehicle 106 has passed object 102₂, this will be detected by the sensors 108, and the illumination of object 102₂ will be terminated, while illumination of object 102₃ by highlighting device 112₃ will be started as soon as vehicle reaches object 102₃.

One effect of this embodiment is that no mechanical components are needed in order to highlight the objects 102. Since mechanical components are prone to errors, highlighting of the objects 102 using light may be more reliable over the time.

FIG. 4 shows possible arrangements of the illumination device (highlighting device 112) of FIG. 3 relative to the corresponding object 102. In FIG. 4a, the highlighting device 112 is located behind the object 102. The illumination device 112 illuminates a back side 142 of the object 102. If the back side 142 is transparent, the light rays may pass through the back side 142 in order to illuminate the front side 140 such that a passenger 114 moving within the vehicle 106 may experience an illuminated front side 140 of the object 102. In FIG. 4b, the highlighting device 112 is placed vis-à-vis the object 102 such that the object 102 is illuminated by the highlighting device 112 directly at its front side 140. Thus, a passenger 114 within the vehicle 106 experiences an illuminated front surface 140 when passing the object 102. In FIG. 4c, the highlighting device 112 is located within the object 102, wherein the highlighting device 112 illuminates the front surface 140 from the back. In this way, the highlighting device 112 is better protected against environmental influences. In FIG. 4d, the highlighting device 112 is positioned over the object 102, however is also horizontally spaced apart a little bit from the object 102 such that the front surface 140 of the object 102 can be illuminated directly from above.

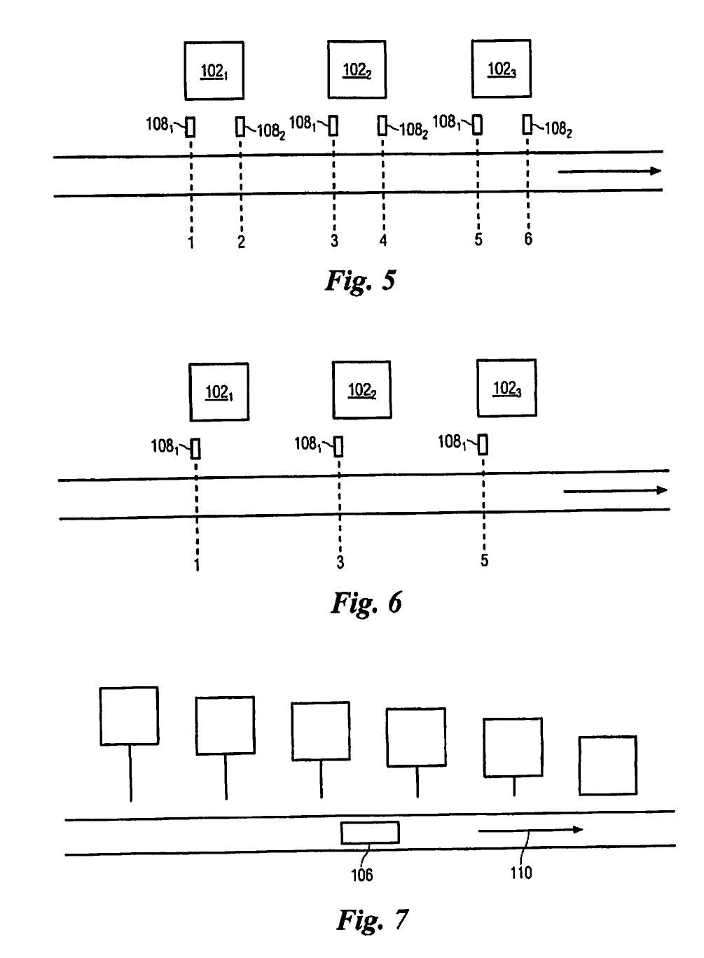

FIG. 5 shows a possible arrangement of the sensors 102. To each of the objects 102, a first sensor 108₁ and a second sensor 108₂ is assigned. For example, sensor 1081 which is assigned to object 102₁ detects whether a vehicle 106 has already passed position 1, and sensor 108₁ causes an illumination device assigned to object 102₁ to highlight object 102₁ as soon as this condition is fulfilled. Similarly, the illumination of object 102₁ is terminated as soon as sensor 108₂ which is assigned to object 102₁ detects that the vehicle 106 has reached position 2. As soon as the vehicle 106 reaches position 3, sensor 108₁ which is assigned to object 102₂ causes an illumination device 112 assigned to object 102₂ to illuminate it, whereas sensor 108₂ assigned to object 102₂ terminates illumination as soon as vehicle 106 reaches position 4, etc.

One effect of this embodiment is that even if the speed of the vehicle varies, a precise control of switching on and off of illumination is possible, thereby guaranteeing a reliable animation effect.

FIG. 6 shows an arrangement of sensors 108 in which, compared to the embodiment shown in FIG. 5, each second sensor 108₂ has been omitted. Each of the sensors 108₁ assigned to the objects 102 triggers the start of the highlighting of the corresponding object 102. However, no sensor is present triggering the end of the highlighting process. However, in order to guarantee that the end of the highlighting process is accordingly triggered, a timer device may be coupled to each of the highlighting devices (not shown) which terminates the highlighting process after a particular amount of time has been passed from the start of the highlighting process. In order to determine the period of time after which the timer terminates the highlighting process, each of the sensors 108₁ may comprise, in addition to a position determining sensor, a speed determining sensor. Based on the speed measurements generated by the speed determining sensors at positions 1, 3 and 5, an estimated period of time may be calculated after which the vehicle should have reached the end of the corresponding object 102, i.e. after which the vehicle 106 should have passed the corresponding object. Based on this period of time, the termination of the highlighting may be triggered by the corresponding timer.

One effect of this embodiment is that the number of sensors can be reduced, thereby saving costs.

In FIGS. 5 and 6, it has been assumed that the sensors are located beside the movement path 104. In this case, the sensors 108 may for example be light sensors or acoustic sensors. However, the sensors may also be placed directly on the surface of the movement path 104 in order to receive a pressure force from the vehicle 106 when passing the sensors, thereby triggering the corresponding highlighting devices.

In FIG. 7, an embodiment is shown in which the height of the object constantly decreases along the movement direction 110. Thus, the impression is given to the passenger within the vehicle 106 that the object 102 is sinking into the ground.

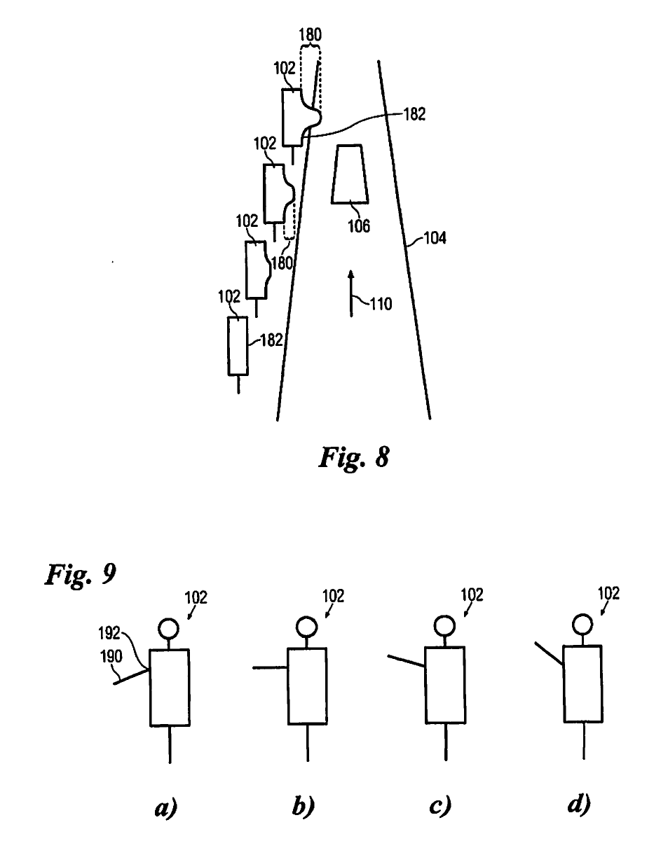

In FIG. 8, a three-dimensional part 180 which extends from the front surface 182 object 102 towards the movement path 104 enlarges from object to object, thereby giving the passenger within the vehicle 106 the impression that the object 102 (at least the three-dimensional part 180) is moving towards the vehicle, or will have the impression that an object is getting out of a board.

Generally, the objects 102 may be two-dimensional objects or three-dimensional objects.

FIG. 9 shows an object 102 comprising a movable part 190 which can be moved relative to the rest of the object 102. In the example given in FIG. 9, the object 102 is a simulation of a human, and the movable part 190 is an arm of the human which can be moved around an axis 192. Four different states of relative alignment between the movable element 190 and the rest of the object 102 are shown (a) to b)). While the vehicle 106 passes the object 102, the movable element 190 may be moved relative to the body of the object 102 as indicated in FIGS. 9 a) to d), thereby contributing to an animation effect.

One effect of this embodiment is that less objects 102 are needed in order to perform an animation.

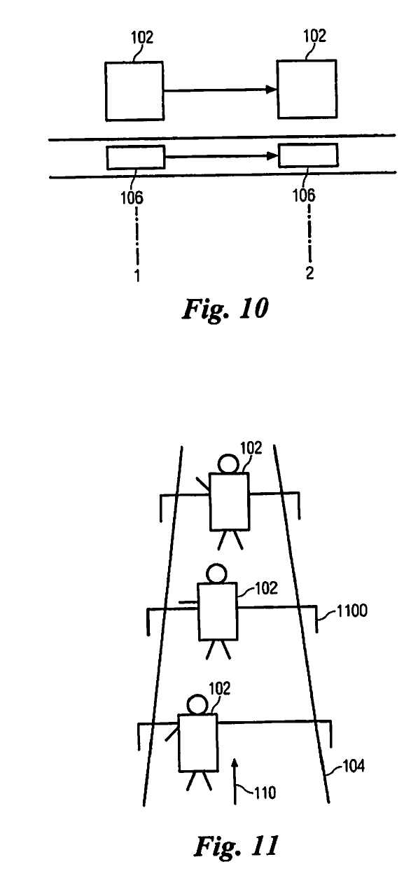

FIG. 10 shows the case where an object 102 is moved parallel to the vehicle 106, i.e. both the object 102 and the vehicle 106 are moved with the same velocity such that the object 102 always faces the vehicle 106. This parallel movement can be done for a particular distance and may for example be carried out if the object 102 is an object as shown in FIG. 9, i.e. a part of the animation is performed by the object 102 itself, and not by a series of objects 102. More generally, a plurality of objects 102 may move together with the vehicle. For example, each object may move with the vehicle 106 for an individual period of time. In this way, for example, it would be possible to show an animation where superman (first moving object) is catching a second moving object (human to be rescued).

FIG. 11 shows an embodiment in which the objects 102 are not placed at the side of a movement path 104 which may for example be a row, railways, an elevator shaft, and the like, but above the movement path 104. Here, the objects are mounted on supporting constructions 1100. In this example, when moving along the movement direction 110, an impression is given that a human moves his arm up.

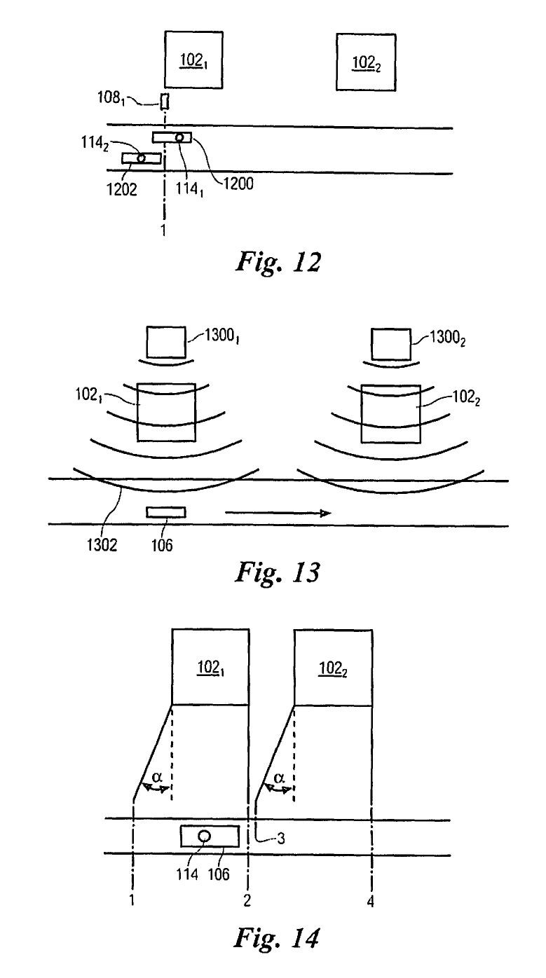

FIG. 12 shows a situation in which a first vehicle 1200 is followed by a second vehicle 1202. The second vehicle 1202 is so close to the first vehicle 1200 that normally highlighting of object 102) would be triggered by sensor 108₁ although the first vehicle 1200 has not yet passed object 102₁. If this was the case, the animation effect viewed by a first passenger 114₁ within the first vehicle 1200 would be disturbed. Thus, according to one embodiment of the present invention, a timer is provided which prevents that a further triggering of highlighting of object 102₁ by the second vehicle 1202 occurs for a particular period of time after the triggering of the highlighting has been caused by the first vehicle 1200. In other words, it is waited until the first vehicle 1200 has passed the object 102₁ before it is possible again to trigger the highlighting of the object 102₁. In this way, it may be prevented for the second passenger 114₂ to experience an animation of objects. However, it can be ensured that at least one of the passengers experiences an undisturbed animation of objects, namely passenger 114₁.

FIG. 13 shows an embodiment in which to each of the objects 102 a sound device 1300 has been assigned. When the vehicle 106 passes the first object 102₁, sound 1302 will be transmitted from the sound device 1300 to the vehicle 106 which makes it possible for the passenger 114 to experience sound corresponding to the animation of objects 102. As soon as the vehicle 106 has passed object 102₁, the sound emitted from the sound device 1300₁ may be switched off and sound 1302₂ emitted from the sound device 1300₂ may be switched off when the vehicle 106 reaches the object 102₂. In this way, sound does only have to be transmitted from one of the sound devices 1300 at one time.

One effect of this embodiment is that not all of the sound devices 1300 do have to emit sound at one time, meaning that it is possible to provide different sound to different passengers 114 experiencing different moments of the object animation.

FIG. 14 shows an embodiment in which the viewing angle range a experienced by a passenger 114 from the beginning of the highlighting of an object 102 to the end of the highlighting of the object 102 is the same for all objects 102. This means that the highlighting of objects 102₁ starts when vehicle 116 is at position 1. Highlighting ends if the vehicle 116 is at position 2. Between position 1 and 2, the viewing angle of the passenger 114 viewing the object 102₁ changes by α. The same viewing angle range will be experienced if the vehicle moves from position 3 to position 4 (i.e. when object 102₂ is highlighted). In this way, the viewing angle only minimally changes from object to object which means that the passenger 114 can more or less look into the same direction for experiencing the animation of objects.

According to an embodiment of the present invention, a may fall into a fixed angle range in all of the animations such that the animation can be viewed from a specific angle range, wherein more frames (objects) are used (duplicated frames that respectively have the same pictures (e.g. four series of frames, wherein each frame of a series respectively has exactly the same picture (like the same face) without changing anything)), and wherein identical frames or objects are attached more close to each other, and wherein the “on” and “off” sensors are positioned more close to each other.

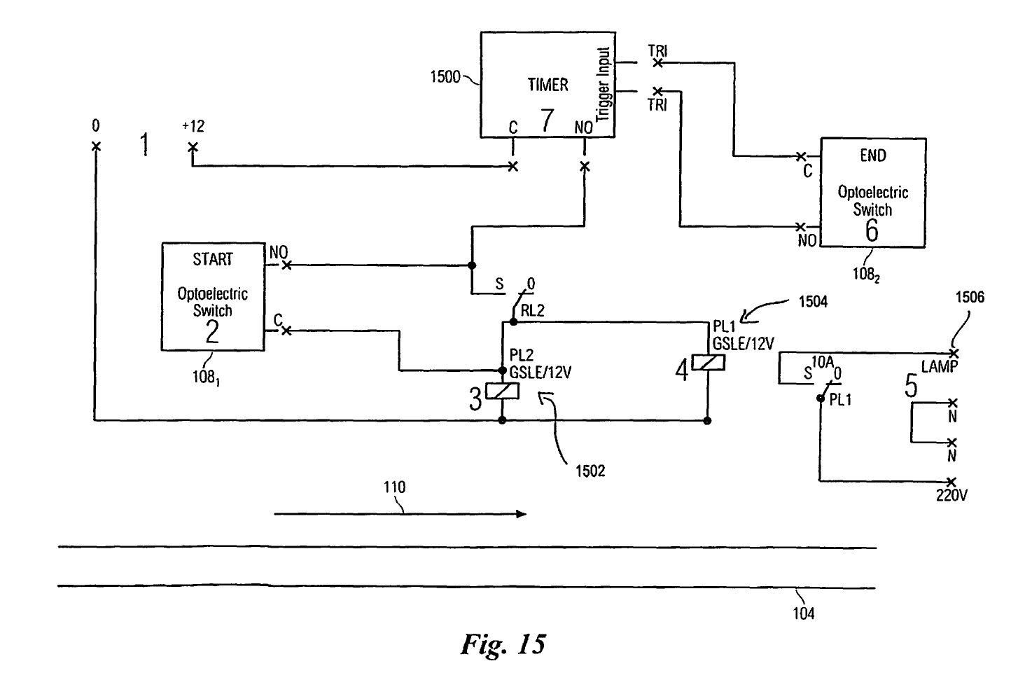

FIG. 15 shows an embodiment in which a timer 1500 is connected to a first sensor 108₁ and to a second sensor 108₂. The first sensor 108₁ is responsible for triggering a start of a highlighting of an object 102 (not shown) assigned to the first sensor 108₁ as soon as a vehicle passes the first sensor 108₁, and the second sensor 108₂ is responsible for triggering an end of a highlighting of the object 102 as soon as a vehicle passes the second sensor 108₂. That is, as soon as a vehicle passes the first sensor 108₁, a lamp (not shown) connected to terminal 1506 is energized by using relays 1502 and 1504, thereby highlighting object 102 assigned to the first sensor 108₁. As soon as the vehicle passes the second sensor 108₂, the lamp connected to terminal 1506 is de-energized using relays 1502 and 1504. At the time when the first sensor 108₁ is triggered, a notification will be given to the timer 1500 by the first sensor 108₁. At the time when the second sensor 108₂ is triggered, a notification will be given to the timer 1500 by the second sensor 108₂. Timer 1500 is responsible for preventing a second triggering of the highlighting of the object 102 for a particular period of time after the first sensor 108₁ has been triggered for the first time (i.e. after the first sensor 108₁ has been triggered by a first vehicle). Alternatively or additionally, the timer 1500 may prevent blocking a second triggering of the highlighting of the object 102 for a particular period of time after the second sensor 108₂ has been triggered for the first time (i.e. after the second sensor 108₂ has been triggered by a first vehicle). This ensures that a passenger of a first vehicle 106 does not experience a disturbed animation of objects if the first vehicle is closely followed by a second vehicle.

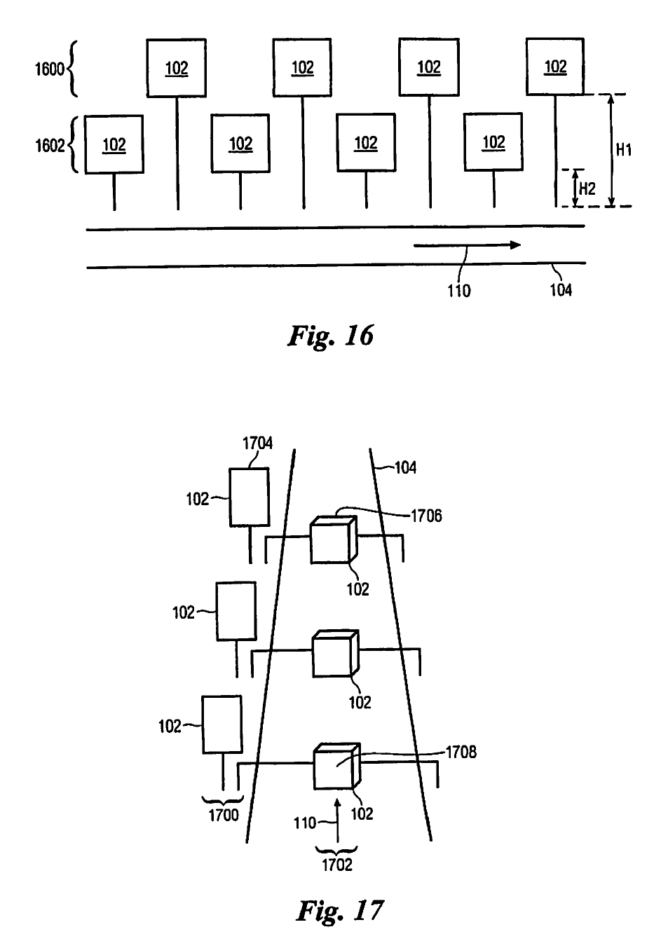

FIG. 16 shows an embodiment in which two different series of objects 102, 1600 and 1602, are shown. In this embodiment, a height H1 of the series 1600 of objects 102 is larger than a height H2 of the series 1602 of objects 102. This means that a passenger of a first vehicle 106 may experience two different animations at the same time. For example, the series 1602 of objects 102 may show a landscape, and the series 1600 of objects 102 may show a superman flying over the landscape. Generally, also more than two series of objects may be presented to a passenger. Instead of placing the objects 102 of series 1600, 1602 in an alternating manner with respect to each other, the objects of different series may also be placed directly above each other.

FIG. 17 shows an embodiment in which a first series 1700 of objects 102 is located besides a road 104, and a second series 1702 of objects 102 is located above a road 104. A passenger moving in a car along road 104 therefore is able to see a first animation mainly caused by varying surfaces 1704 of the objects 102 of series 1700 (which can be viewed by the passenger by looking to the side), and an animation mainly caused by a varying surfaces 1706 of the objects 102 of series 1702 (which can be viewed by the passenger by looking to the back of the car, e.g. by using a mirror of the car). In this way, for example, series 1700 may simulate a first superman flying besides the road 104 (besides the car), and series 1702 may simulate a first superman flying above the road 104 (behind the car). If surfaces 1708 of objects 102 of series 1702 are mainly responsible for causing an animation, the passenger will experience a superman flying in front of the car.

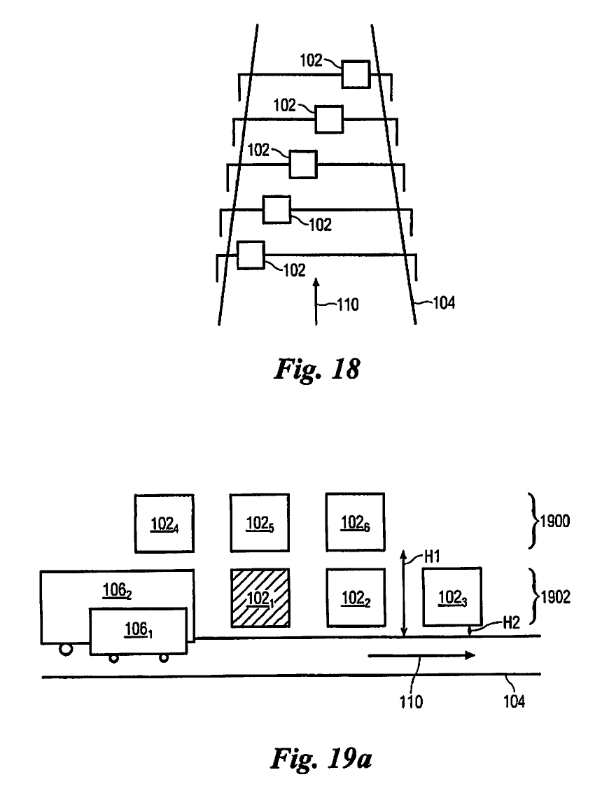

FIG. 18 shows an embodiment in which a series of objects 102 is mounted above the road. When moving within vehicle 106 along direction 110, an impression is given that an object 102 is moving from the left to the right.

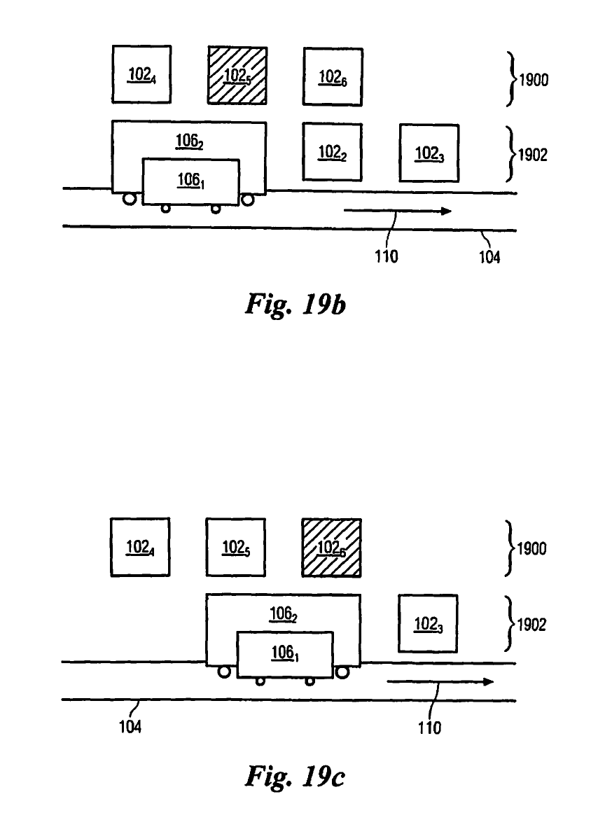

FIG. 19a shows an embodiment in which two different series of objects 102, 1900 and 1902, are shown. In this embodiment, a height H1 of the series 1900 of objects 102 is larger than a height H2 of the series 1902 of objects 102. At the point of time shown in FIG. 19a, only object 102₁ of series 1902 is highlighted. This gives the passenger of vehicle 106, the impression that object 102₁ is almost hit by vehicle 106₁.

At the point of time shown in FIG. 19b, only object 102₅ of series 1900 is highlighted. This gives the passenger of vehicle 106₁ the impression that object 102₁ has surprisingly jumped onto vehicle 106₂.

At the point of time shown in FIG. 19c, only object 102₆ of series 1900 is highlighted. This gives the passenger of vehicle 106₁ the impression that object 102₁ still is above vehicle 106₂.

Thus, as can be derived from FIGS. 19a to 19c, several series of objects (here: series 1900 and 1902) may be used in order to simulate an arbitrary kind of movement like an up- or down-movement, a left to right movement, front to back movement or any other kind of movement of an object like superman. According to one embodiment of the present invention, vehicle 106₂ is a real vehicle which is used as a part of the animation. That is, vehicle 106₂ is used to give the passenger of vehicle 106₁ the impression that superman is waiting for vehicle 106₂ until he is almost hit and then jumps onto vehicle 106₂. In order to give this impression, vehicle 106₂ may move besides 106₁ or may overtake 106₁. The highlighting of objects 102 may be triggered by sensors reacting on the movement of vehicle 106₁ and/or 106₂. The speed of vehicle 106₂ may be automatically adapted to the speed of the vehicle 106₁ in order to guarantee an animation without disturbance. Vehicle may be a vehicle driven by a human or a vehicle automatically driven (e.g. using a guiding means like a railway).

In FIG. 19, there has been shown the case where an animation is created by vehicle 106₂ which moves besides vehicle 106₁ or which overtakes vehicle 106₁. Alternatively, vehicle 106₂ may move in front of vehicle 106₁ so that a passenger located within the vehicle 106₁ always views the vehicle 106₂ from the back. For example, an animation may be viewed by the first vehicle 106₁ in the back that a superman is trying to carry the second vehicle 106₂, and some monsters are getting out of the second vehicle 106₂.

According to an embodiment of the present invention, the vehicle 106 may drive through a tunnel, wherein at the walls, ceiling or the bottom of the tunnel the objects 102 are provided such that the whole tunnel serves for an animation. For example, an animation may be generated in which the objects 102 move in circles around the moving vehicle (i.e. above, below, and besides the vehicle).

All kinds of animations as shown above can be arbitrarily combined.

According to an embodiment of the present invention, the viewing angle can be arbitrarily chosen and only depends on the viewing circumstances, e.g. on the relative distance between the objects and the viewer (passenger), the size of the objects, the moving speed of the vehicle, the kind of the vehicle, etc. For example, if the vehicle is a transparent vehicle, it is possible to install objects such that they appear above the vehicle or below the vehicle since the passenger is able to look through the bottom or ceiling of the vehicle and is therefore able to see objects above the vehicle or below the vehicle.

According to an embodiment of the present invention, the objects are arbitrary natural or artificial objects like stones, trees, imitations of humans or animals, real (living) humans or animals, and the like.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A system for creating a visual animation of objects which can be experienced by a passenger located within a moving vehicle, the system comprising:
a plurality of objects being placed along a movement path of the vehicle,
a plurality of sensors being assigned to the plurality of objects and being arranged such along the movement path that the vehicle actuates the sensors when moving along the movement path,
a plurality of highlighting devices being coupled to the plurality of sensors and being configured such that, in accordance with sensor actuations triggered by the movement of the vehicle,
a) only one of the plurality of objects is highlighted by the highlighting devices to the passenger at one time,
b) the objects are highlighted to the passenger in such a sequence that the passenger visually experiences an animation of the objects.

2. The system according to claim 1, wherein the sensors are light sensors, infrared sensors, pressure sensors or acoustic sensors.

3. The system according to claim 2, wherein, to each of the objects, a first sensor is respectively assigned which triggers a start of the highlighting of the corresponding object.

4. The system according to claim 3, wherein, to each of the objects, a second sensor is respectively assigned, wherein the second sensor triggers an end of the highlighting of the corresponding object.

5. The system according to claim 4, wherein a first timer device is respectively connected to each highlighting device, wherein each first timer device is configured to automatically trigger an end of the highlighting of the object as soon as a particular period of time after the start of the highlighting of the object has been passed.

6. The system according to claim 5, further comprising a plurality of speed measurement devices coupled to the plurality of highlighting devices, wherein each speed measurement device is configured to measure the speed of the moving vehicle, wherein the particular period of time is determined based on the speed measurement.

7. The system according to claim 6, wherein a second timer device is respectively connected to each sensor, wherein each second timer device is configured to block highlighting of an object if the object has already been highlighted within a particular period of time immediately before.

8. The system according to claim 7, wherein the triggering of the start of the highlighting and the triggering of the end of the highlighting is carried out such that the viewing angle range experienced by the passenger is the same for each of the successive objects viewed.

9. The system according to claim 8, wherein the vehicle is a car, a train, a bus, a subway, an elevator, a motor bike, or a bike.

10. The system according to claim 9, wherein each highlighting device comprises an illumination device.

11. The system according to claim 10, wherein each illumination device is positioned within an object or in front of an object or behind or above or at one side or at two sides of an object or at an arbitrary position spaced away from the object and is configured to illuminate the object as soon as the start of the highlighting of the object has been triggered, and to end illumination of the object as soon as the end of the highlighting of the object has been triggered.

12. The system according to claim 11, wherein each highlighting device comprises a shielding device comprising a shielding element being positioned in front of the object, wherein the shielding device is configured to remove the shielding element to enable visibility of the object as soon as the start of the highlighting of the corresponding object has been triggered, and to place the shielding element in front of the object as soon as the end of the highlighting of the corresponding object has been triggered.

13. The system according to claim 12, wherein the objects are placed substantially along a line which runs in parallel to the movement path of the vehicle.

14. The system according to claim 13, wherein the line of objects runs beside the movement path or above or at the front or at the back of the movement path or movement position of the vehicle.

15. (canceled)

16. The system according to claim 14, wherein the objects are two-dimensional or three-dimensional objects.

17. The system according to claim 16, wherein at least some objects are movable as a whole in parallel or perpendicular to the movement path of the vehicle.

18. The system according to claim 17, wherein at least some of the objects are stationary as a whole, however parts of the objects are movable in correspondence with the highlighting of the objects such that the movement of the parts of the objects form a part of the animation.

19. The system according to claim 18, wherein at least some of the objects are enlargeable.

20. The system according to claim 19, wherein the plurality of objects is split up into at least two series of objects, the objects of each series of objects being respectively aligned along the movement path such that the passenger experiences one animation or simultaneously at least two different animations when moving along the movement path.

21. The system according to claim 20, wherein an animation is displayed by highlighting objects of a first series of objects and is then displayed by highlighting objects of a second series of objects, wherein the switching between the first series and the second series is triggered by a further vehicle moving besides the vehicle of the passenger, or both series of objects are displayed at the same time.

22. The system according to claim 21, further comprising a plurality of sound devices assigned to the plurality of objects, wherein the sound devices create sound in a way that the passenger located within the vehicle experiences a continuous sound pattern when passing the objects which correspond to the animation of the objects.

23. The system according to claim 22, wherein the plurality of sound devices coupled to the plurality of sensors is configured such that the generation of sound of a sound device is started as soon as the start of the highlighting of the corresponding object is triggered by the sensors, and is terminated as soon as the end of the highlighting of the corresponding object is triggered.

24. The system according to claim 23, further comprising a wireless sound transmitting device being configured to transmit sound information to a wireless sound receiving device located within the vehicle.

25. The system according to claim 24, wherein the viewing angle is chosen arbitrarily and depends only on the viewing circumstances of the viewer.
